(19) United States
(12) Patent Application Publication
(10) Pub. No.: US 2006/0035612 A1
(43) Pub. Date: Feb. 16, 2006

(54) Receiver

(76) Inventors: Hiroshi Miyagi, Niigata (JP); Tsuyoshi Koike, Aichi (JP)

Correspondence Address: DELLETT & WALTERS, P. O. BOX 82788, PORTLAND, OR, 97282-0788, US

(21) Appl. No.: 10/533,358

(22) PCT Filed: Oct. 14, 2003
(86) PCT No.: PCT/JP03/13106

§ 371 Date: Apr. 29, 2005

(30) Foreign Application Priority Data
Oct. 29, 2002 (JP) 2002-314642

(51) Int. Cl. H04B 17/00

(52) U.S. Cl. 455/226.1; 455/67.11

(57) ABSTRACT

There is provided a receiver not requiring a complicated connection for an operation test and capable of reducing the test time and simplifying the device configuration. An output signal of an oscillator 21 used for generating a reference signal input to a PLL circuit 20 connected to a local oscillator 13 is divided by a divider 24 to generate a test signal contained in a reception band of the AM broadcast. This test signal is input via a switch 25 to a high frequency amplification circuit 11 and an intermediate frequency signal for this test signal is input to a level detector 30. When the AM receiver operates normally, the output of a voltage comparator 31 becomes high level.

### TECHNICAL FIELD

The present invention relates to a receiver for receiving a signal within a predetermined reception band.

### BACKGROUND ART

In a radio broadcast, a signal obtained by modulating a voice signal with a modulation method, such as AM modulation or FM modulation, is sent out from a broadcasting station. The radio receiver outputs an original voice signal by demodulating a received signal by a method corresponding to the modulation method. When the assembling of such receiver is completed, an operation test is carried out for checking whether or not the receiver performs the reception operation normally. For example, the operation test is performed by connecting a measurement system for the operation test to a receiver to be tested (for example, pages 1 to 2, FIG. 7 of International Patent Publication No. WO 00/14912). The measurement system is constituted by including a signal generator, a low frequency analyzer, a personal computer, etc., and measurement condition data of a carrier wave frequency and a modulation method, etc. are transmitted from the personal computer to the radio receiver and the signal generator, so as to enable the operation test for the receiver to be performed.

There is also known a radio receiver in which a signal generating section, etc. required for performing the operation test is incorporated for allowing self-diagnosis (see pages 2 to 5, Figures 1 to 4 of Japanese Patent Laid-Open No. 7-131429). The radio receiver, which comprises a pseudo code generator, a pseudo code collator and an oscillator/modulator, etc., is capable of performing the operation test by the receiver itself.

However, the measurement system disclosed in International Patent Publication No. WO 00/14912 described above, has a problem in that other devices, such as a signal generator need to be connected in the exterior of the receiver, thereby causing the connection for the operation test to be complicated and the operation test to be time consuming.

In the radio receiver disclosed in Japanese Patent Laid-Open No. 7-131429 described above, such complexity of connection is not caused because the self-diagnosis is performed, but the radio receiver also has a problem in that the oscillator/modulator for signal generation is needed in the receiver, thereby causing the configuration to be complicated.

### DISCLOSURE OF THE INVENTION

The present invention has been made in view of the above-described circumstances. An object of the present invention is to provide a receiver in which the need of complicated connection for the operation test can be eliminated for reducing the test time, and in which the device configuration can also be simplified.

In order to solve the above described problem, according to the present invention, there is provided a receiver comprising: a crystal oscillator for generating a signal required for reception operation of a broadcast wave; a signal generation unit for generating a test signal for an operation test by using an output signal of the crystal oscillator; an input unit for inputting the test signal to an antenna input section when the operation test is performed; and a determining unit for determining quality of reception operation based on a measured signal generated when the reception operation for the test signal is performed. Since components for generating the test signal required for the operation test, and components for performing quality determination of the test result are included in the receiver, complicated connections with external measuring devices etc. in performing the operation test are not needed, as a result of which the time required for the operation test can be reduced. Since the test signal is generated by using the output signal of the crystal oscillator, the device configuration of the receiver can be simplified compared with the case where the components required for generating the test signal are provided additionally.

Specifically, the above-described input unit is preferably a switch provided between the signal generation unit and the antenna input section. This enables the test signal to be easily and surely inputted to the antenna input section at the time of the operation test.

In addition, the above described crystal oscillator is preferably used for generating a reference signal inputted to a frequency synthesizer for generating a local oscillation signal. In recent years, receivers provided with the frequency synthesizer have increased from a viewpoint of improving operability and commodity value. In such receivers, the crystal oscillator is an essential component, and the device configuration, with the crystal oscillator being used for test signal generation, can be simplified through the common use of components.

The above described crystal oscillator is also preferably used for generating a clock signal required for operation of logic circuits. In recent years, as in the case of the above described frequency synthesizer, receivers provided with logic circuits such as CPU, have increased from a viewpoint of achieving multi-functionality and improving commodity value. In such receivers, a crystal oscillator for generating a clock signal required for operation of logic circuits is an essential component, and the device configuration, with the crystal oscillator being used for test signal generation, can be simplified through the common use of components.

The receiver preferably comprises an AM circuit which performs reception operation for an AM modulation wave signal inputted to the above described antenna input section, and it is preferable that a frequency of a signal obtained by dividing the output signal of the crystal oscillator is included in the frequency band of the AM modulation wave signal. Alternatively, the receiver preferably comprises a FM circuit which performs reception operation for an FM modulated wave signal inputted to the above described antenna input section, and it is preferable that a frequency of a signal obtained by multiplying the output signal of the crystal oscillator is included in the frequency band of the FM modulated wave signal. As a result, a crystal resonator of a general-purpose natural oscillation frequency (for example, 17.1 MHz) can be used, thereby enabling component costs to be reduced.

The receiver preferably comprises a switching control unit for switching the above described reception operation of broadcast waves and the determination operation performed by the determining unit using the measured signal. Thereby, a test signal can be surely inputted to the antenna input section only at the time of the operation test.

The above described signal generation unit is also preferably a frequency divider for generating the test signal having a frequency included in the reception band of broadcast waves, by dividing the output signal of the crystal oscillator. The test signal with high frequency accuracy can be generated only by dividing the output signal of the crystal oscillator, thereby enabling the device configuration to be further simplified.

The above described signal generation unit is also preferably a PLL circuit and an oscillator, which generate the test signal having a frequency included in the reception band of broadcast waves, by using the output signal of the crystal oscillator as a reference signal. Alternatively, the above described signal generation unit is preferably a frequency synthesizer for generating the test signal having a frequency included in the reception band of broadcast waves, by using the output signal of the crystal oscillator as a reference signal. As a result, the device configuration can be simplified compared with the case where a crystal oscillator is provided exclusively for generating the test signal with high frequency accuracy.

The above described signal generation unit is also preferably a multiplier for generating the test signal having a frequency included in the reception band of broadcast waves, by multiplying the output signal of the crystal oscillator. The test signal with high frequency accuracy can be generated only by multiplying the output signal of the crystal oscillator, thereby enabling the device configuration to be further simplified.

Further, the above described measured signal is preferably an intermediate frequency signal generated by mixing the test signal and a local oscillation signal, and it is preferable that the intermediate frequency signal is detected by the determining unit. As a result, the quality of reception operation of the receiver can be decided, when a test signal with a single frequency corresponding to a carrier wave of a predetermined frequency is inputted, as a result of which the device configuration required for the operation test can be simplified.

Further, the above described measured signal is preferably a signal after a detection processing is applied to the intermediate frequency signal, and it is preferable that the signal subjected to the detection processing is detected by the determining unit. Since the signal subjected to the detection processing is superposed with a DC component corresponding to the amplitude of the carrier wave, the quality of reception operation of the receiver can be determined by detecting the level of the DC component, as a result of which the device configuration required for the operation test can be simplified.

It is also preferred to provide a notifying unit for notifying the quality of reception operation, based on the result of determination by the above described determining unit. In particular, a display unit for displaying contents of the broadcast waves in reception is preferably used as the notifying unit. Alternatively, the notifying unit is preferably an illumination unit for notifying the quality of reception operation, depending on the lighting state of the illumination unit. Thereby, the quality of reception operation as a result of the operation test can be confirmed only by means of the receiver, so that the need for other devices to be connected merely for finding the test result can be eliminated, and the configuration and connection can also be simplified.

### BRIEF DESCRIPTION OF THE DRAWINGS

FIG. 1 a figure showing a configuration of an AM receiver of a first embodiment;

FIG. 2 a figure showing an operation procedure of the AM receiver at the time of an operation test;

FIG. 3 is a figure partially showing a modification of the AM receiver according to the first embodiment;

FIG. 4 is a figure partially showing a modification of the AM receiver according to the first embodiment;

FIG. 5 is a figure showing a configuration of an FM receiver according to a second embodiment; and

FIG. 6 is a figure showing a configuration of a receiver according to a third embodiment.

### BEST MODE FOR CARRYING OUT THE INVENTION

Hereafter, an AM receiver of an embodiment according to the present invention will be described with reference to the accompanying drawings.

### First Embodiment

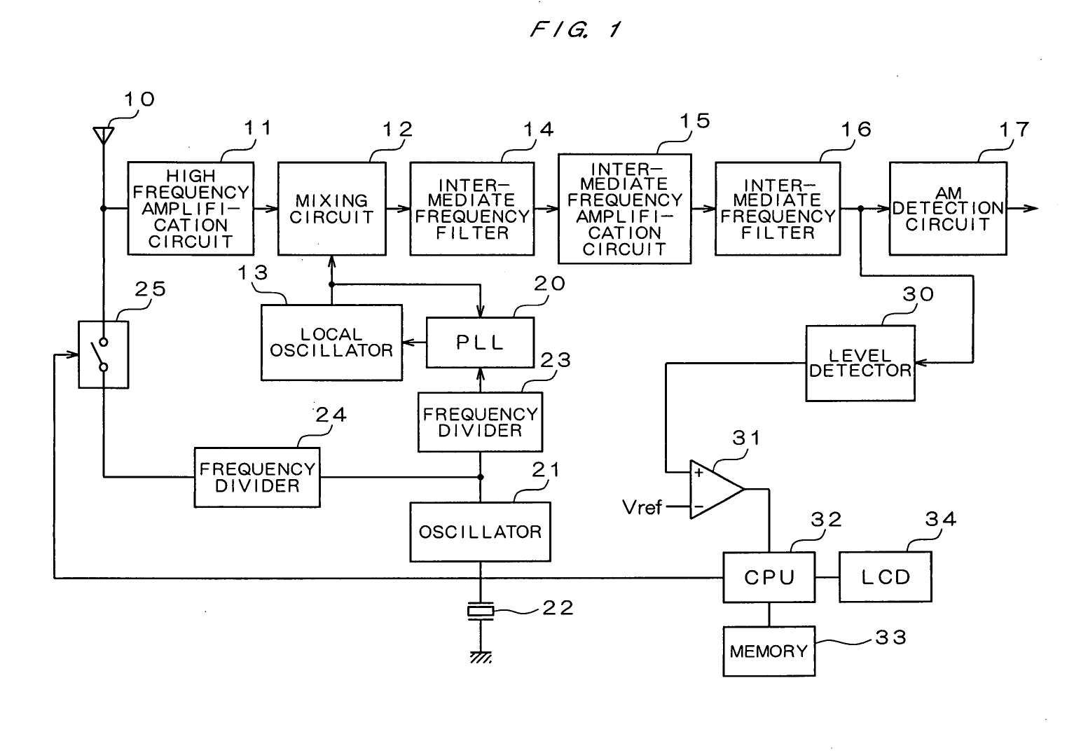

FIG. 1 is a figure showing a configuration of an AM receiver according to a first embodiment. As shown in FIG. 1, the AM receiver according to the present embodiment is constituted by including a high frequency amplification circuit 11, a mixing circuit 12, a local oscillator 13, intermediate frequency filters 14, 16, an intermediate frequency amplification circuit 15, an AM detection circuit 17, a PLL circuit 20, an oscillator 21, a crystal resonator 22, frequency dividers 23, 24, a switch 25, a level detector 30, a voltage comparator 31, a CPU 32, a memory 33 and a LCD (liquid crystal display device) 34.

An AM modulation wave signal received with an antenna 10 is amplified by the high frequency amplification circuit 11 and then mixed with a local oscillation signal outputted from the local oscillator 13, thereby effecting a conversion from a high frequency signal to an intermediate frequency signal. If the frequency of the amplified AM modulation wave signal outputted from the high frequency amplification circuit 11 is f1, and the frequency of the local oscillation signal outputted from the local oscillator 13 is f2, the intermediate frequency signals having frequencies of f1±f2 are outputted from the mixing circuit 12. For example, a conversion to an intermediate frequency signal of 450 kHz is effected.

The intermediate frequency filters 14, 16, which are provided for the preceding and subsequent stages of the intermediate frequency amplification circuit 15, extract frequency components included in the occupied frequency band of the modulation wave signal from the inputted intermediate frequency signal. The intermediate frequency amplification circuit 15 amplifies the intermediate frequency signal. The AM detection circuit 17 applies AM detection processing to the intermediate frequency signal which has been amplified by the intermediate frequency amplification circuit 15.

The oscillator 21, which uses the crystal resonator 22 as a part of a resonance circuit, performs an oscillation operation at the natural oscillation frequency f₀ of the crystal resonator 22 (in practice, at a frequency fᵣ slightly higher than f₀). For example, the oscillator 21 performs the oscillation operation at 17.1 MHz.

The PLL circuit 20 constitutes a frequency synthesizer together with the local oscillator 13, and performs control for making the local oscillator 13 oscillate at a frequency of N-fold of a reference signal generated by dividing the signal outputted from the oscillator 21 with the frequency divider 23. The value of N can be arbitrarily changed by the CPU 32, and the oscillation frequency of the local oscillator 13 can be switched by changing the value of N.

The frequency divider 24 performs frequency-dividing of the signal of 17.1 MHz outputted from the oscillator 21, so as to generate a test signal of a predetermined frequency included in the reception band of AM broadcast. For example, a division ratio of the frequency divider 24 is set to “18”, so as to make a test signal of 950 kHz (17.1 MHz/18) outputted.

The switch 25 is controlled to be in an on-state at the time of an operation test of the AM receiver. The output terminal of the frequency divider 24 and the input terminal (antenna input section) of the high frequency amplification circuit 11 are connected via the switch 25, so that when the switch is in the on-state, the signal of 950 kHz generated by the frequency divider 24 is inputted to the high frequency amplification circuit 11.

The level detector 30 detects the level of the output signal of the intermediate frequency filter 16 at the time of the operation test. For example, the peak of the output signal of the intermediate frequency filter 16 is held so as to make the level of the signal detected. The voltage comparator 31, to the positive side of input terminal of which the output signal of the level detector 30 is inputted and to the negative side of input terminal of which a predetermined reference voltage Vref is inputted, outputs a high level signal, when the level of the output signal of the level detector 30 exceeds the reference voltage Vref.

The CPU 32 provides control over the whole receiving operation of the AM receiver, and also provides control over switching operation required for the operation test and displaying the test result. Specifically, the CPU 32 puts the switch 25 into the on-state at the time of the operation test and receives the output signal of the voltage comparator 31, so as to determine the quality of the operation test result. The memory 33 stores operation programs of the CPU 32 and the result of the operation test. The LCD 34, of which display contents are controlled by the CPU 32, is used to display contents of broadcast waves in reception and the result of the operation test.

The above described oscillator 21 and crystal resonator 22 correspond to the crystal oscillator, and the frequency divider 24 to the signal generation unit. The level detector 30, the voltage comparator 31 and the CPU 32 correspond to the determining unit, and the switch 25 corresponds to the input unit. The CPU 32 corresponds to the switching control unit, and the LCD 34 corresponds to the notifying unit and the display unit, respectively.

The AM receiver according to the present embodiment has a configuration as described above, and the operation thereof will be described below.

At the time of normal reception operation, the switch 25 is controlled to be in an off-state by the CPU 32, so as to prevent the output signal of the frequency divider 24 from being inputted to the input terminal of the high frequency amplification circuit 11. In this state, the AM modulation wave signal received by the antenna 10 is inputted to the high frequency amplification circuit 11 so that a desired broadcast wave can be received with the division ratio N of the frequency divider in the PLL circuit 20 set by the CPU 32.

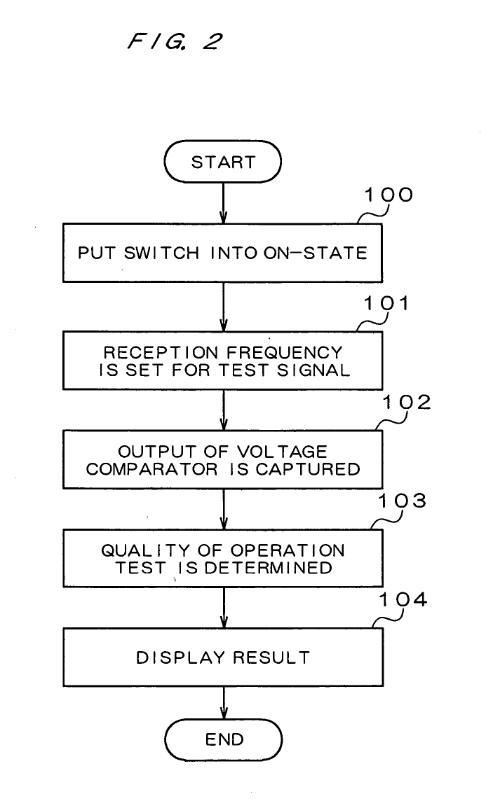

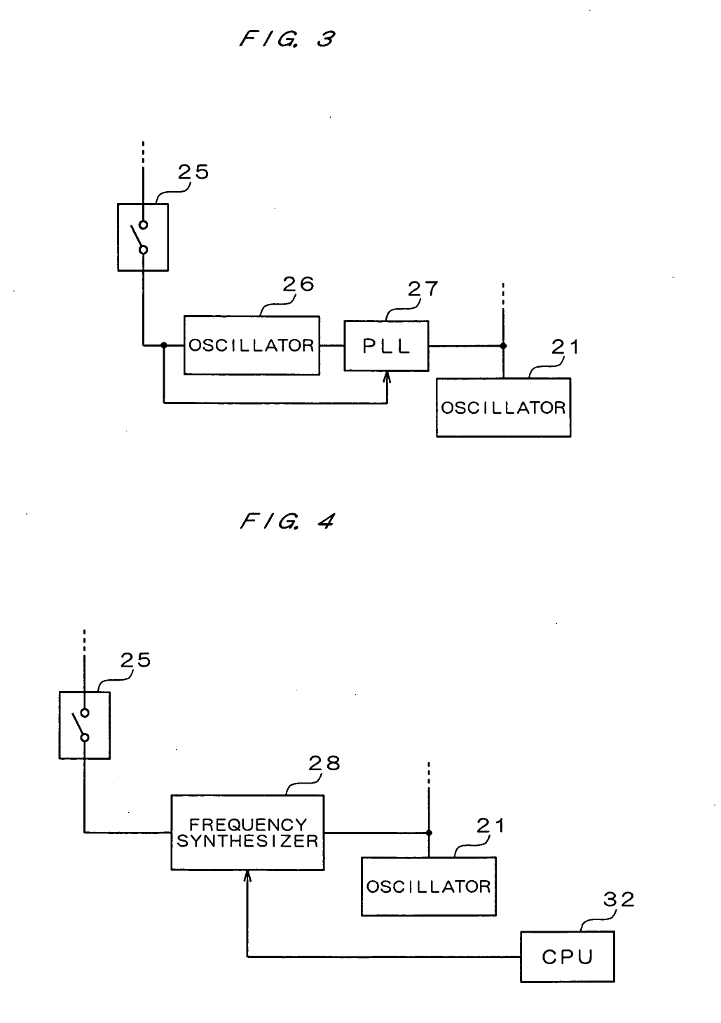

Prior to the above described normal reception operation, for example, at the completion of assembling of the AM receiver, an operation test is performed for checking whether or not the AM receiver is operating normally. FIG. 2 is a flow chart showing an operation procedure of the AM receiver at the time of the operation test, in which flowchart the procedure of control operation performed by the CPU 32 is mainly illustrated.

First, the CPU 32 puts the switch 25 into the on-state (step 100). Thereby, the test signal of 950 kHz outputted from the frequency divider 24 is inputted to the input terminal of the high frequency amplification circuit 11 via the switch 25.

Then, the CPU 32 sets the reception frequency to the frequency (950 kHz) of the test signal (step 101). For example, the division ratio of the frequency divider in the PLL circuit 20 is set to a value corresponding to the frequency of the test signal, and the frequency of the local oscillation signal outputted from the local oscillator 13 is set to a predetermined value. In practice, the tuning frequency of the antenna tuning circuit and the RF tuning circuit in the high frequency amplification circuit 11 is also arranged to match with the frequency of the test signal. When the input of the test signal and the setting of the reception frequency are thus completed, an intermediate frequency signal corresponding to the test signal is outputted from the mixing circuit 12, so as to be inputted to the level detector 30 via the intermediate frequency filter 14, the intermediate frequency amplification circuit 15 and the intermediate frequency filter 16.

Then, the CPU 32 receives the output of the voltage comparator 31 (step 102) and then determines the quality of the operation test result based on the contents of the received data (step 103). In the case where a normal reception operation is performed for the test signal, the intermediate frequency signal corresponding to the test signal is outputted from the intermediate frequency filter 16, so that the output signal of the level detector 30 reaches a predetermined level. A high level signal is thus outputted from the voltage comparator 31. In the case where the output signal of the voltage comparator 31 is at the high level, the CPU 32 determines that the operation test result is normal. Conversely, in the case where the output signal of the voltage comparator 31 is at the low level, the CPU 32 determines that the operation test result is unsatisfactory. Then, the CPU 32 displays by using the LCD 34 the contents of quality determination of the result of the operation test (step 104).

As described above, the AM receiver according to the present invention, in which components for generating the test signal required for performing the operation test and components for determining the quality of the test result are incorporated, is capable of performing self-diagnosis of the operating state without using an external measuring device etc., and need not be connected with the external measuring device etc., as a result of which the test time can be reduced by eliminating the time required for effecting such connection.

The AM receiver according to the present invention also generates a test signal required for the operation test, by making the frequency divider 24 divide the output signal of the oscillator 21 used for generating the reference signal inputted to the PLL circuit 20, thereby eliminating the oscillator used only for generating the test signal, and enabling the device configuration to be simplified. In particular, the test signal with high frequency accuracy can be generated only by dividing the output signal of the oscillator 21, thereby enabling the device configuration to be further simplified. The switch 25 which is provided between the frequency divider 24 and the high frequency amplification circuit 11 also enables the test signal to be easily and reliably inputted to the high frequency amplification circuit 11 at the time of the operation test.

In the case where the frequency synthesizer is provided as in the case of the AM receiver according to the present embodiment, the crystal oscillator consisting of the oscillator 21 and the crystal resonator 22, is an essential component. By using the crystal oscillator for generating the test signal, the device configuration can be further simplified through the common use of components.

In the AM receiver according to the present embodiment, the intermediate frequency signal outputted from the intermediate frequency filter 116 is taken as a measured signal, and the level of the measured signal is detected. This enables the quality determination of reception operation of the AM receiver to be reliably performed, when a test signal of a single frequency corresponding to a carrier wave of a predetermined frequency is inputted to the high frequency amplification circuit 11 via the switch 25.

The reception operation of broadcast waves (AM modulation wave signals) and the test operation using the level detector 30, etc. are also switched by turning on or off the switch 25 by the CPU 32, so that the test signal can be reliably inputted to the high frequency amplification circuit 11 only at the time of the operation test.

Since the quality of reception operation as the result of the operation test can be confirmed by means of the receiver by making the result of the quality determination by the CPU 32 displayed in the LCD 34, other devices to be connected only for finding the test result are eliminated so that the configuration and connection can be simplified.

FIG. 3 is a figure partially showing a modification of the AM receiver according to the present embodiment. In the AM receiver shown in FIG. 1, the frequency divider 24, as the signal generation unit, for dividing the output signal of the oscillator 21 is provided between the oscillator 21 for performing oscillation operation using the crystal resonator 22 and the switch 25, but as shown in FIG. 3, the frequency divider 24 as the signal generation unit may be replaced by an oscillator 26 and a PLL circuit 27. The PLL circuit 27 provides control over the oscillation operation of the oscillator 26 by using the output signal of the oscillator 21 as a reference signal, so as to generate a signal which is synchronized with the reference signal and which has a frequency equal to 1/M (M is integer) multiple of the frequency of the reference signal. For example, in the case where the frequency of the output signal of the oscillator 21 is 17.1 MHz, the value of M is set to be 18, the oscillation operation at 950 kHz is performed in the oscillator 26.

In this way, since the use of the oscillator 26 in combination with the PLL circuit 27 also enables self-diagnosis of operating states to be performed without using an external measuring device etc., the connection to the external measuring device, etc. is not needed, so that the test time can be reduced by eliminating the time required for the connection. Since the test signal is generated by using the output signal of the oscillator 21 used for generating the reference signal inputted to the PLL circuit 20 connected to the local oscillator 13, the configuration can also be simplified compared with the case where an oscillator using a crystal resonator for generating the test signal is independently provided.

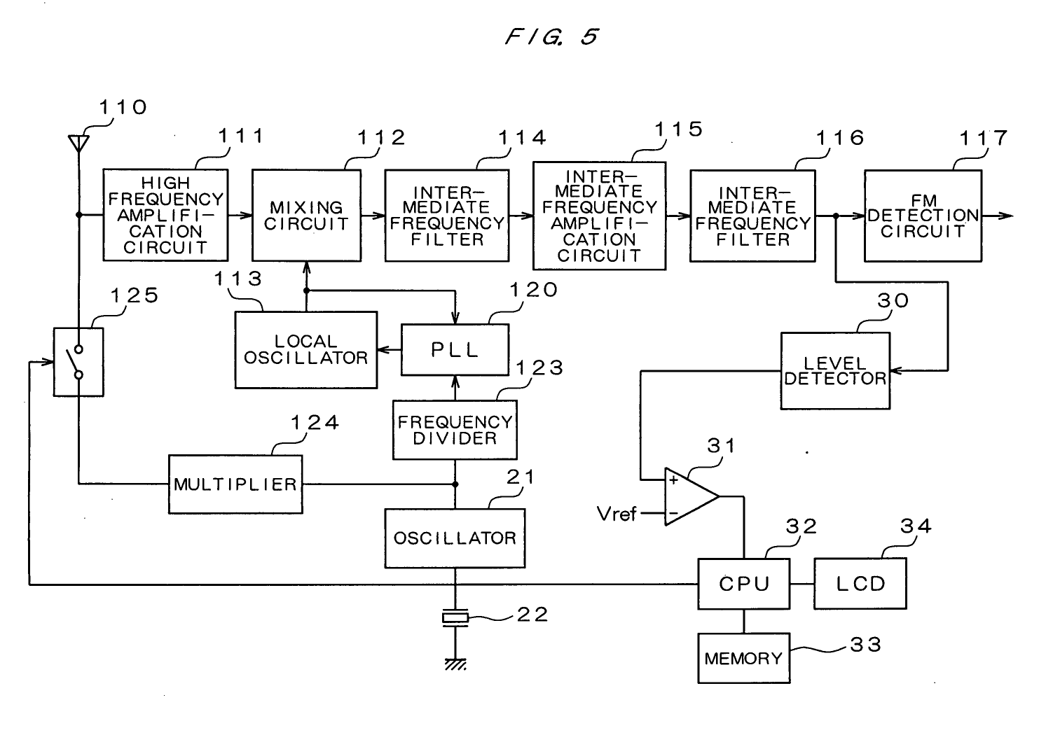

The test signal is generated by the oscillator 26 in combination with the PLL circuit 27 in the configuration shown in FIG. 3, but as shown in FIG. 4, the test signal of a predetermined frequency may also be arranged to be generated by using the frequency synthesizer 28 instead of the oscillator 26 and the PLL circuit 27, in accordance with a frequency setting instruction from the CPU 32. A frequency divider may also be arranged to be used so as to be inserted into the preceding stage or the subsequent stage of the oscillator 26 shown in FIG. 3, or of the frequency synthesizer 28 shown in FIG. 4.

### Second Embodiment

Although the configuration for performing the operation test in the AM receiver is explained in the above described embodiment, the present invention can also be applied to an FM receiver by slightly changing the configuration.

FIG. 5 is a figure showing a configuration of an FM receiver according to a second embodiment. As shown in FIG. 5, the FM receiver according to the present embodiment is constituted by including a high frequency amplification circuit 111, a mixing circuit 112, a local oscillator 113, intermediate frequency filters 114, 116, an intermediate frequency amplification circuit 115, an FM detection circuit 117, a PLL circuit 120, an oscillator 21, a crystal oscillator 22, a frequency divider 123, a multiplier 124, a switch 125, a level detector 30, a voltage comparator 31, a CPU 32, a memory 33 and a LCD 34. The FM receiver shown in FIG. 5 has a configuration similar to that of the AM receiver shown in FIG. 1, and the following description will be made mainly in view of the difference between these configurations. The same arrangements as in the AM receiver shown in FIG. 1 are given the same reference numerals, and the detailed explanation of which arrangements is omitted.

The FM modulation wave signal received by the antenna 110 is amplified by the high frequency amplification circuit 111, and then mixed with the local oscillation signal outputted from the local oscillator 113 so as to be converted from the high frequency signal to an intermediate frequency signal. For example, the conversion to the intermediate frequency signal of 10.7 MHz is effected.

Intermediate frequency filters 114, 116 are provided for the preceding stage and the subsequent stage of the intermediate frequency amplification circuit 115, and extract frequency components included in the occupied frequency band of the modulation wave signal from the inputted intermediate frequency signal. The intermediate frequency amplification circuit 115 amplifies the intermediate frequency signal. The FM detection circuit 117 applies FM detection processing to the intermediate frequency signal amplified by the intermediate frequency amplification circuit 115.

The multiplier 124 multiplies a signal of 17.1 MHz outputted from the oscillator 21, and generates a test signal of a predetermined frequency included in the reception band of FM broadcasting. For example, the test signal of 85.5 MHz (=17.1 MHz×5) is outputted by multiplying the signal of 17.1 MHz by five.

The FM receiver according to the present embodiment is provided with the above described configuration, in which an operation test is performed in the same manner as the AM receiver according to the first embodiment. That is, at the time of the operation test, the switch 125 is controlled by the CPU 32 to be an on-state, and the test signal of 85.5 MHz outputted from the multiplier 124 is inputted to the input terminal of the high frequency amplification circuit 111. The test signal is converted to an intermediate frequency signal of a predetermined frequency by the mixing circuit 112, and thereafter outputted from the intermediate frequency filter 116 through the intermediate frequency filter 114 and the intermediate frequency amplification circuit 115, and then detected by the level detector 30. Thus, the output of the voltage comparator 31 becomes a high level, and the CPU 32 determines the quality of the operation test result based on the output signal of the voltage comparator 31 and displays the determination result in the LCD 34.

As described above, the FM receiver according to the present embodiment, in which components for generating the test signal required for performing the operation test and components for determining the quality of the test result are incorporated, is capable of performing self-diagnosis without using an external measuring device etc. and of eliminating connections with the external measuring device etc., thereby enabling the test time to be reduced by eliminating the time required for effecting the connections.

The FM receiver according to the present embodiment, which generates the test signal required for the operation test by multiplying with the multiplier 124 the output signal of the oscillator 21 used for generating the reference signal inputted to the PLL circuit 120, is also capable of eliminating an oscillator used only for generating the test signal, thereby enabling the configuration to be simplified. In particular, the test signal with high frequency accuracy can be generated only by multiplying the output signal of the oscillator 21, as a result of which the device configuration can be further simplified.

### Third Embodiment

Although the case where the present invention is applied to the AM receiver or the FM receiver is explained in the above described embodiments, the present invention can also be applied to a receiver provided with functions of both the AM and FM receivers.

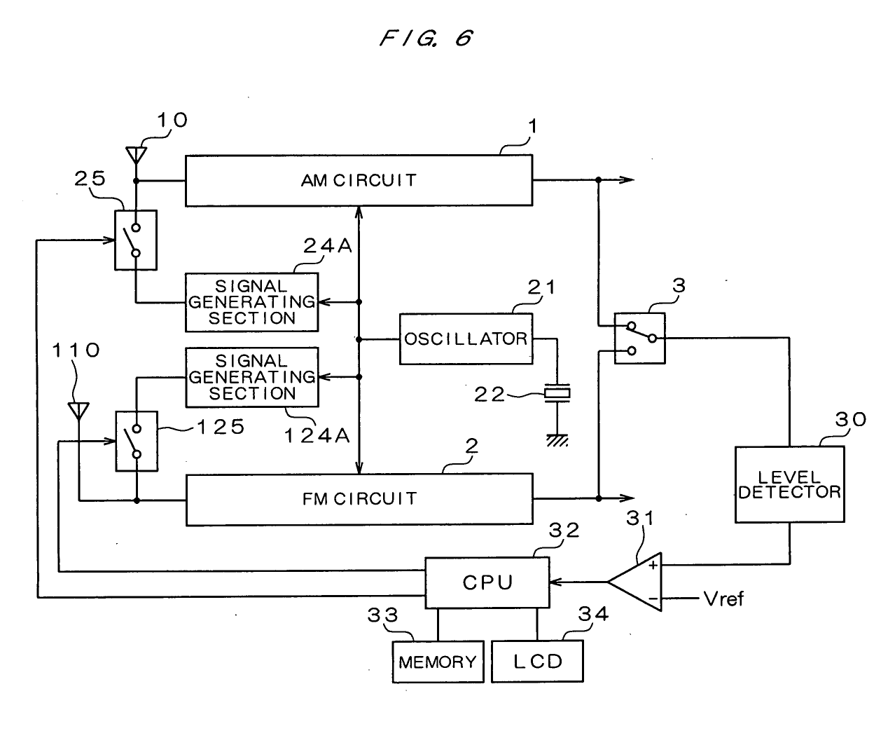

FIG. 6 is a figure showing a configuration of a receiver according to a third embodiment. As shown in FIG. 6, the receiver according to the present embodiment is constituted by including a AM circuit 1, an FM circuit 2, a selector switch 3, an oscillator 21, a crystal resonator 22, signal generating sections 24A, 124A, switches 25, 125, a level detector 30, a voltage comparator 31, a CPU 32, a memory 33, and a LCD 34.

The AM circuit 1, which corresponds to those including the high frequency amplification circuit 11, the mixing circuit 12, the local oscillator 13, the intermediate frequency filters 14, 16, the intermediate frequency amplification circuit 15, the PLL circuit 20 and the frequency divider 23, which are shown in FIG. 1, receives an AM modulation wave signal received by the antenna 10 and a test signal inputted via the switch 25, and outputs an intermediate frequency signal corresponding to the AM modulation wave signal and the test signal.

The FM circuit 2, which corresponds to those including the high frequency amplification circuit 111, the mixing circuit 112, the local oscillator 113, the intermediate frequency filters 114, 116, the intermediate frequency amplification circuit 115, the PLL circuit 120 and the frequency divider 123, which are shown in FIG. 5, receives an FM modulation wave signal received by the antenna 110 and a test signal inputted via the switch 125, and outputs an intermediate frequency signal corresponding to the FM modulation wave signal and the test signal.

The intermediate frequency signal outputted from either the AM circuit 1 or the FM circuit 2 at the time of the operation test is selected by the selector switch 3 and inputted to the level detector 30. The level detector 30, the voltage comparator 31, the CPU 32, the memory 33, and the LCD 34 are the same as those shown in FIG. 1 or FIG. 5, and a set of components common to the AM circuit 1 and the FM circuit 2 is provided.

The signal generating section 24A generates the test signal required for the operation test using the AM circuit 1, based on a signal outputted from the oscillator 21 connected to the crystal resonator 22. The frequency divider 24 shown in FIG. 1, the oscillator 26 and the PLL circuit 27 shown in FIG. 3, and the frequency synthesizer 28 shown in FIG. 4 correspond to the signal generating section 24A as the signal generation unit. The signal generating section 124A generates the test signal required for the operation test using the FM circuit 2, based on a signal outputted from the oscillator 21 connected to the crystal resonator 22. The multiplier 124 shown in FIG. 5 corresponds to the signal generating section 124A as the signal generation unit.

The receiver according to the present embodiment is provided with the above described configuration, and the operation test is performed successively for each of the AM circuit 1 and the FM circuit 2. First, only one of the switches 25, which corresponds to the AM circuit 1, is controlled by the CPU 32 to be the on-state so as to make the test signal of a predetermined frequency (for example, 950 kHz) outputted from the signal generating section 24A is inputted to the AM circuit 1. In the case where the AM circuit 1 operates normally, the test signal is converted to an intermediate frequency signal so as to be outputted from the AM circuit 1. At this time, the selector switch 3 is switched to the side of the AM circuit 1 under control of the CPU 32, and the intermediate frequency signal outputted from the AM circuit 1 is inputted to the level detector 30 via the selector switch 3 so that the level detection is performed by the level detector 30. The output signal of the level detector 30 is inputted to the voltage comparator 31, and the CPU 32 determines the quality of the operation test result of the AM circuit 1, based on the output signal of the voltage comparator 31, for displaying the determination result in the LCD 34.

Next, only the other switch 125 corresponding to the FM circuit 2 is controlled by the CPU 32 to be the on-state, and the test signal of a predetermined frequency (for example, 85.5 MHz) outputted from the signal generating section 124A is inputted to the FM circuit 2. In the case where the FM circuit 2 is operates normally, the test signal is converted to an intermediate frequency signal so as to be outputted from the FM circuit 2. At this time, the selector switch 3 is switched to the side of the FM circuit 2 under control of the CPU 32, and the intermediate frequency signal outputted from the FM circuit 2 is inputted to the level detector 30 via the selector switch 3 so that the level detection is performed by the level detector 30. The output signal of the level detector 30 is inputted to the voltage comparator 31, and the CPU 32 determines the quality of the operation test result of the FM circuit 2, based on the output signal of the voltage comparator 31, for displaying the determination result in the LCD 34.

In this way, the receiver according to the present embodiment, in which components (signal generating sections 24A, 124A) for generating the test signal required for performing the operation test for each of the AM circuit 1 and the FM circuit 2 and components for determining the quality of the test result are incorporated, is capable of performing self-diagnosis without using an external measuring device etc. and eliminating connections with the external measuring device etc., thereby enabling the test time to be reduced by eliminating the time required for effecting the connections.

The receiver according to the present embodiment, in which the test signal is generated by the signal generating sections 24A, 124A using the output signal of the oscillator 21 required for generating the local oscillation signal in either the AM circuit 1 or the FM circuit 2, is also capable of eliminating an oscillator used only for generating the test signal, thereby enabling the configuration to be simplified.

Also, in the receiver according to the present embodiment, the AM circuit 1 for performing reception operation for AM modulation wave signals is provided, and the crystal resonator 22 is selected so that a frequency of a signal obtained by dividing the output signal of the oscillator 21 is included in the frequency band of the AM modulation wave signals (as same as in the case of the receiver according to the first embodiment). Alternatively, the FM circuit 2 for performing reception operation for FM modulation wave signals is provided, and the crystal resonator 22 is selected so that a frequency of a signal obtained by multiplying the output signal of the oscillator 21 is included in the frequency band of the FM modulation wave signals (also as same as in the case of the receiver according to the second embodiment). As a result, the crystal resonator 22 of a general purpose natural oscillation frequency (for example, 17.1 MHz) can be used, thereby enabling components costs to be reduced.

The present invention is not limited to the above described embodiments, and various variations are possible within the scope and spirit of the invention. For example, although the result of the operation test is arranged to be displayed in the LCD 34 in the above embodiments, the test result may be arranged to be stored in the memory 33, and to be read out afterwards from the memory 33 by an external reader (for example, personal computer).

In the above described embodiment, the level of the intermediate frequency signal is arranged to be detected by the level detector 30 so as to make the operation test performed, but the operation test may be arranged to be performed by using other methods such as for detecting the distortion factor of the signal.

All of the components except the antennas 10, 110, the crystal oscillator 22 and the LCD 34 are formed on the semiconductor substrate so as to realize a single chip structure, thereby making it possible to simplify the manufacturing process and to reduce the cost by decreasing the number of components, though a range in which these semiconductor substrate is not described in the above described embodiment.

In the above described embodiment, the test signal is arranged to be generated based on the output signal of the oscillator 21 used for generating the reference signal inputted to the PLL circuit 20, but in the case where another crystal oscillator using the crystal resonator is provided in the receiver, for example, in the case where a crystal oscillator for generating a clock signal required for operating logic circuits such as the CPU 32, the test signal may also be arranged to be generated based on the output signal of such crystal oscillator. Especially in these days, receivers provided with logic circuits such as the CPU 32 have been increasing from a viewpoint of achieving multi-functionality and improving commodity value, and the like. In such receivers, a crystal oscillator for generating a clock signal required for operating logic circuits is an essential component, and the device configuration with such crystal oscillator being used for test signal generation, can be simplified through the common use of components.

The quality of the test result is determined by using the CPU 32, but may also be arranged to be determined by using simple logic circuits instead of the CPU 32. For example, in view of the simplest case, the output terminal of the voltage comparator 31 may arranged to be connected with a LED (light emitting diode) as the illumination unit for notifying the quality of reception operation depending on the illumination condition, so as to make the LED turned on when the output signal of the voltage comparator 31 is at a high level.

In the above described embodiment, the outputs of the intermediate frequency filters 16, 116 are arranged to be inputted to the level detector 30, but the outputs of the AM detection circuit 17 and the FM detection circuit 117 may also be arranged to be inputted to the level detector 30. For example, the output of the AM detection circuit 17 is superposed with a DC component corresponding to the amplitude of the carrier wave, and the level of the DC component may also be arranged to be detected by level detector 30. This enables the device configuration required for the operation test to be simplified.

### INDUSTRIAL APPLICABILITY

As described above, according to the present invention, since components for generating the test signal required for the operation test and components for performing the quality determination of the test result are included in the receiver, complicated connections with external measuring devices etc. are not needed at the time of the operation test, as a result of which the time required for the operation test can be reduced. Since the test signal is generated by using the output signal of the crystal oscillator, the device configuration of the receiver can also be simplified as compared with the case where a configuration required for generating the test signal independently provided.

1. A receiver comprising:
a crystal oscillator for generating a signal required for reception operation of broadcast waves;
a signal generation unit for generating a test signal for an operation test by using an output signal of said crystal oscillator;
an input unit for inputting the test signal to an antenna input section when the operation test is performed; and
a determining unit for determining quality of reception operation based on a measured signal generated when reception operation is performed for the test signal.

2. The receiver according to claim 1, wherein said input unit is a switch provided between said signal generation unit and said antenna input section.

3. The receiver according to claim 1, wherein said crystal oscillator is used for generating a reference signal inputted to a frequency synthesizer for generating a local oscillation signal.

4. The receiver according to claim 1, wherein said crystal oscillator is used for generating a clock signal required for operating logic circuits.

5. The receiver according to claim 1, comprising an AM circuit for performing reception operation for an AM modulation wave signal inputted to said antenna input section, wherein
a frequency of a signal obtained by dividing the output signal of said crystal oscillator is included in a frequency band of said AM modulation wave signal.

6. The receiver according to claim 1, comprising an FM circuit for performing reception operation for an FM modulation wave signal inputted to said antenna input section, wherein
a frequency of a signal obtained by multiplying the output signal of said crystal oscillator is included in a frequency band of said FM modulation wave signal.

7. The receiver according to claim 1, comprising a switching control unit for switching the reception operation of said broadcast waves and the determination operation by said determining unit using the measured signal.

8. The receiver according to claim 1, wherein said signal generation unit is a frequency divider for generating said test signal having a frequency included in a reception band of the broadcast waves by dividing the output signal of said crystal oscillator.

9. The receiver according to claim 1, wherein said signal generation unit is a PLL circuit and a oscillator for generating said test signal having a frequency included in a reception band of the broadcast waves by using the output signal of said crystal oscillator as a reference signal.

10. The receiver according to claim 1, wherein said signal generation unit is a frequency synthesizer for generating said test signal having a frequency included in a reception band of the broadcast waves by using the output signal of said crystal oscillator as a reference signal.

11. The receiver according to claim 1, wherein said signal generation unit is a multiplier for generating said test signal having a frequency included in a reception band of the broadcast waves by multiplying the output signal of said crystal oscillator.

12. The receiver according to claim 1, wherein said measured signal is an intermediate frequency signal generated by mixing said test signal and a local oscillation signal, and
wherein said determining unit detects a level of said intermediate frequency signal.

13. The receiver according to claim 1, wherein said measured signal is a signal after a detection processing is applied to the intermediate frequency signal, and
wherein said determining unit detects a level of the signal subjected to said detection processing.

14. The receiver according to claim 1, further comprising a notifying unit for notifying quality of reception operation based on the determination result of said determining unit.

15. The receiver according to claim 14, wherein a display unit for displaying contents of the broadcast waves in reception is used as said notifying unit.

16. The receiver according to claim 14, wherein said notifying unit is an illumination unit for notifying quality of reception operation depending on a lighting state.
